(19) United States
(12) Patent Application Publication
(10) Pub. No.: US 2008/0144846 A1
(43) Pub. Date: Jun. 19, 2008

(54) Circuit for detecting when a microphone is connected and method for use therewith

(76) Inventors: Nelson R. Sollenberger, Farmingdale, NJ (US); Hongwei Kong, Denville, NJ (US); Andy Ye Tong, Redwood City, CA (US); Todd L. Brooks, Laguna Beach, CA (US)

Correspondence Address: GARLICK HARRISON & MARKISON, P.O. BOX 160727, AUSTIN, TX, 78716-0727, US

(21) Appl. No.: 11/641,552

(22) Filed: Dec. 18, 2006

(51) Int. Cl. H04R 29/00

(52) U.S. Cl. 381/58

(57) ABSTRACT

A circuit for detecting when a microphone is connected to a microphone coupling includes a detection signal generator that asserts a microphone detection signal. A microphone power module supplies a microphone current to the microphone coupling in response to the assertion of the microphone detection signal. A microphone detection module detects when the microphone is not connected to the microphone coupling based on an impedance of the microphone coupling, wherein the microphone power module disconnects the microphone current from the microphone coupling when the microphone is not connected to the microphone coupling. In an embodiment, the circuit further detects when a microphone button is depressed.

### BACKGROUND OF THE INVENTION

1. Technical Field of the Invention

This invention relates generally to audio integrated circuits and more particularly to detector for detecting whether a microphone is connected to an integrated circuit, such as a combined voice, data and RF integrated circuit.

2. Description of Related Art

As is known, integrated circuits are used in a wide variety of products including, but certainly not limited to, portable electronic devices, computers, computer networking equipment, home entertainment, automotive controls and features, and home appliances. As is also known, integrated circuits include a plurality of circuits in a very small space to perform one or more fixed or programmable functions.

Integrated circuits can include audio processing circuitry that is coupled to a microphone for processing voice or other audio signals generated by the microphone. In some circumstances, the microphone can be selectively coupled or decoupled to the circuit. When the microphone element is powered, such as in the case of an electret microphone element, power can be saved by providing power to the microphone only when the microphone is present.

The advantages of the present invention will be apparent to one skilled in the art when presented with the disclosure herein.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of another communication system in accordance with the present invention;

FIG. 3 is a schematic block diagram of an embodiment of an integrated circuit in accordance with the present invention;

FIG. 4 is a schematic block diagram of another embodiment of an integrated circuit in accordance with the present invention;

FIG. 5 is a schematic block diagram of an embodiment of microphone detection circuitry in accordance with the present invention;

FIG. 6 is a flow chart of an embodiment of a method in accordance with the present invention; and

FIG. 7 is a flow chart of an embodiment of a method in accordance with the present invention.

### DETAILED DESCRIPTION OF THE INVENTION

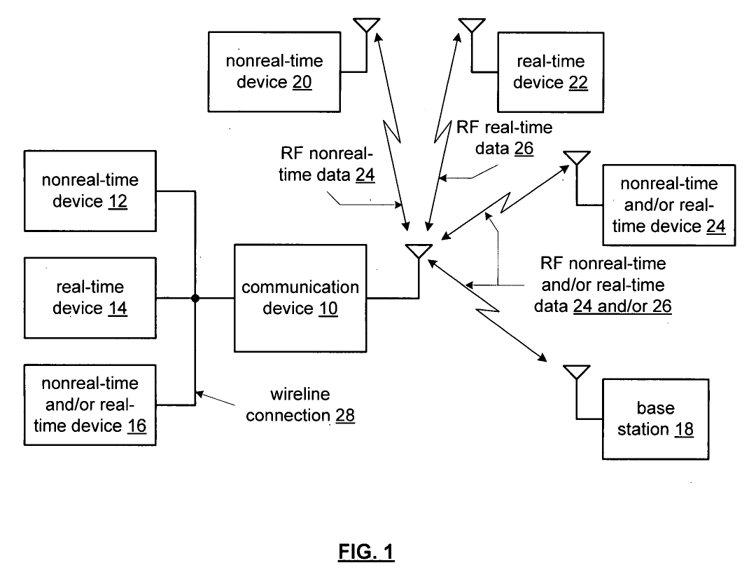

FIG. 1 is a schematic block diagram of an embodiment of a communication system in accordance with the present invention. In particular a communication system is shown that includes a communication device 10 that communicates real-time data 24 and non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12 real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDSs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

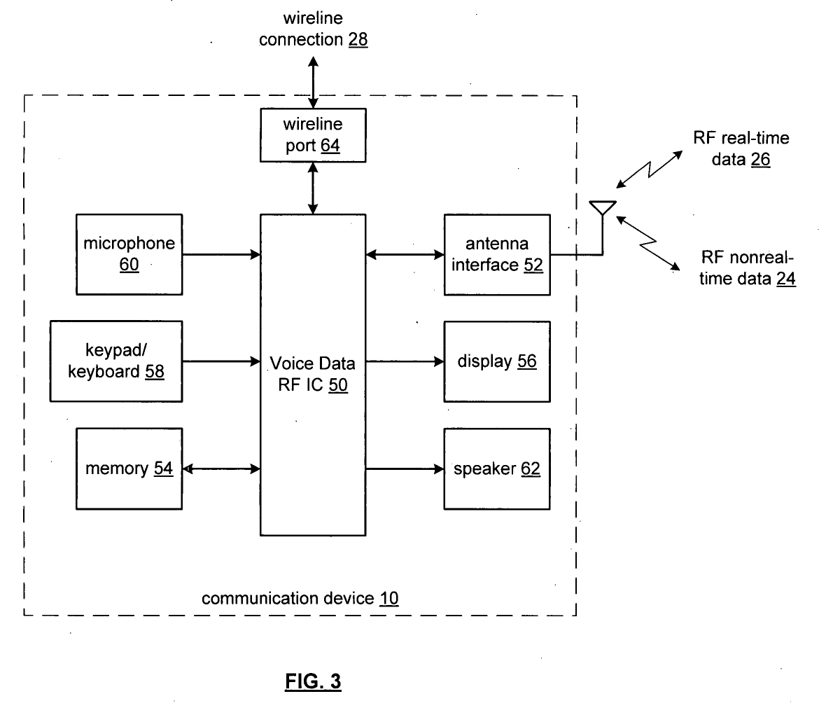

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 3-7 that follow.

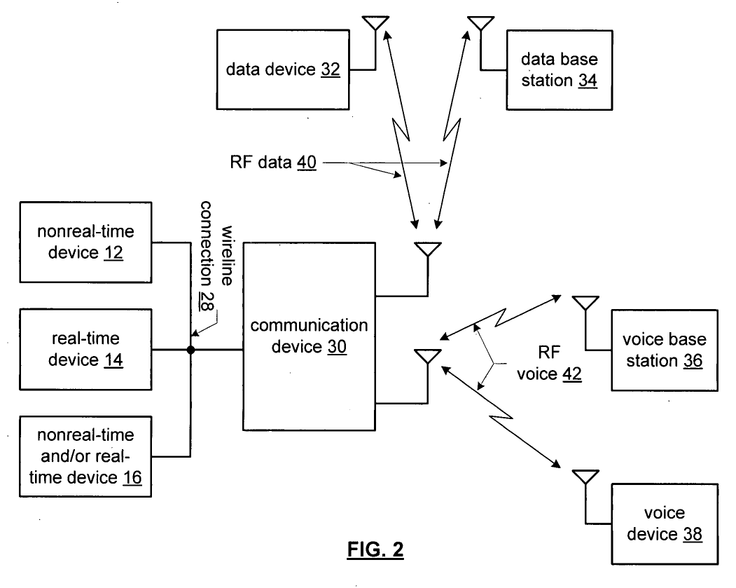

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two separate wireless transceivers for communicating, contemporaneously, via two or more wireless communication protocols with data device 32 and/or data base station 34 via RF data 40 and voice base station 36 and/or voice device 38 via RF voice signals 42.

FIG. 3 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, antenna interface 52 and wireline port 64. In operation, voice data RF IC 50 includes RF and baseband modules for formatting and modulating data into RF real-time data 26 and non-real-time-data 24 and transmitting this data via an antenna interface 52 and antenna. In addition, voice data RF IC 50 includes the appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62.

In an embodiment of the present invention, the voice data RF IC is a system on a chip integrated circuit that includes at least one processing device. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the Voice Data RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

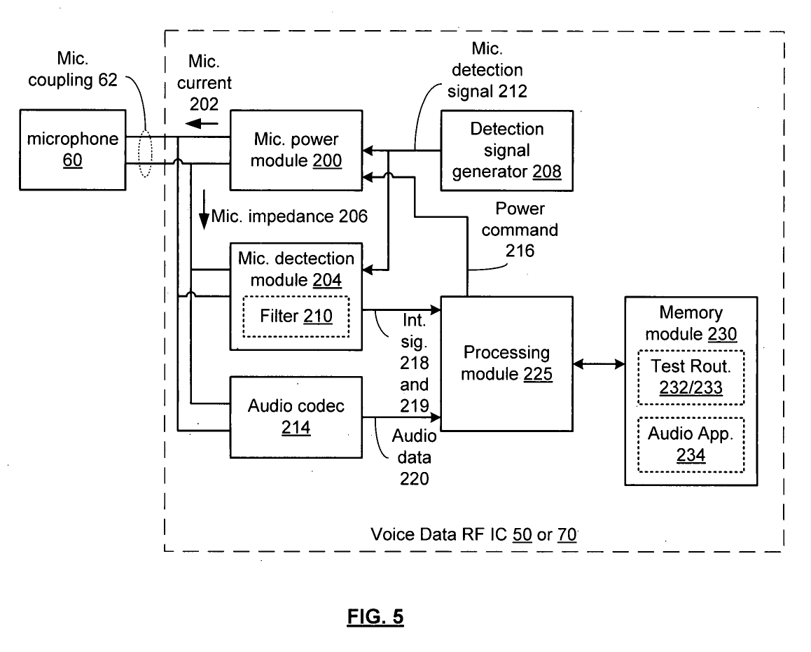

In operation, the voice data RF IC 50 executes operational instructions that implement one or more of the applications (real-time or non-real-time) attributed to communication devices 10 and 30 as discussed in conjunction with FIGS. 1 and 3. Further, RF IC 50 includes microphone detection circuitry in accordance with the present invention that will be discussed in greater detail in association with FIG. 5.

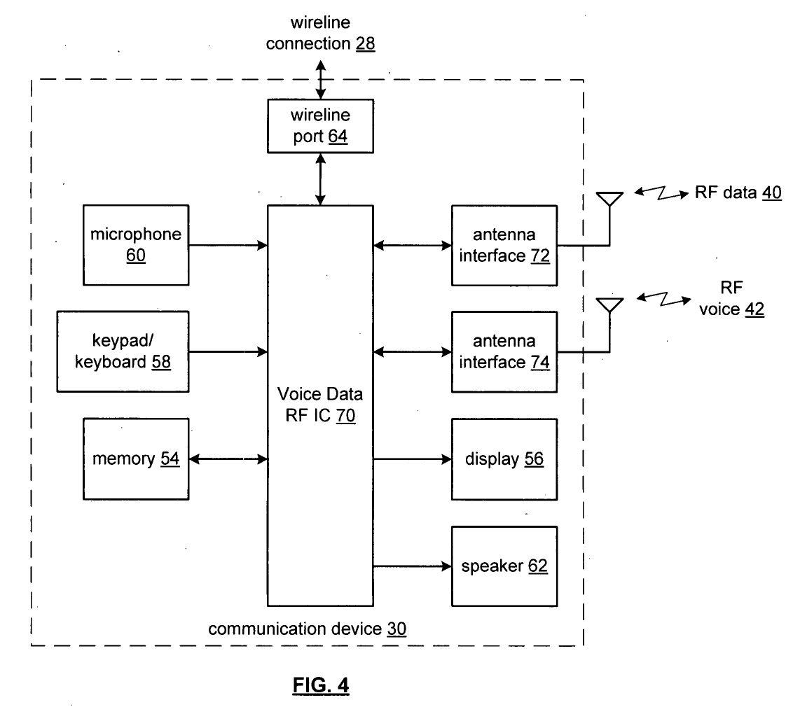

FIG. 4 is a schematic block diagram of another embodiment of an integrated circuit in accordance with the present invention. In particular, FIG. 4 presents a communication device 30 that includes many common elements of FIG. 3 that are referred to by common reference numerals. Voice data RF IC 70 is similar to voice data RF IC 50 and is capable of any of the applications, functions and features attributed to voice data RF IC 50 as discussed in conjunction with FIG. 3. However, voice data RF IC 70 includes two separate wireless transceivers for communicating, contemporaneously, via two or more wireless communication protocols via RF data 40 and RF voice signals 42.

In operation, the voice data RF IC 70 executes operational instructions that implement one or more of the applications (real-time or non-real-time) attributed to communication device 10 as discussed in conjunction with FIG. 1. Further, RF IC 70 includes microphone detection circuitry in accordance with the present invention that will be discussed in greater detail in association with FIG. 5.

FIG. 5 is a schematic block diagram of an embodiment of microphone detection circuitry in accordance with the present invention. In particular, a circuit is shown that is implemented as part of voice data RF IC 50 and/or 70 for detecting when microphone 60 is connected to a microphone coupling 62. The microphone coupling 62 can include a plug and jack combination, such as a subminiature phone plug and jack or other connector. In accordance with the present invention, the microphone 60 includes an electret microphone such as a foil-type, diaphragm-type, back electret or front electret microphone, other condenser microphone or other microphone that operates from en external power source. The microphone 60 operates when powered by a microphone current 202 supplied by microphone power module 200 to generate microphone signals that can be sampled and encoded by audio codec 214 to produce audio data 220 used by processing module 225 for one or more voice applications such as the voice dependant applications described in conjunction with communication devices 10 and/or 30 and stored in either an on-chip memory module 230 (as shown) or in an off-chip memory module such as memory 54. Further, microphone 60, through microphone coupling produces a microphone impedance or equivalently, microphone current draw, either at DC, at low frequencies, such as subaudible frequencies, or other frequencies that can be used to determine the state of connection of the microphone 60 and whether or not a microphone button is depressed—such as the difference between when a microphone is powered in a standby mode or powered and is generating voice signals. The microphone detection circuit further includes a microphone detection module 204, and detection signal generator 208.

In accordance with the present invention, the microphone detection circuit selectively supplies microphone current 202 to the microphone coupling 62 until a microphone is detected or until the button is pressed indicating a voice communication activity is about to begin. By not powering the microphone coupling continuously, the microphone power module 200 consumes less power.

In operation, the detection signal generator 208 asserts a microphone detection signal 212. In response, the microphone power module 200 supplies the microphone current 202 to the microphone coupling 62 and to microphone 60, if it is attached. The microphone detection module 204 detects when the microphone is not connected to the microphone coupling based on an impedance of the microphone coupling or the current draw by the emicrophone. In an embodiment of the present invention, a high impedance or low current draw indicates that no microphone is detected. Conversely, a lower impedance or high current draw indicates that microphone 60 is connected. Further, an even lower impedance or even higher current draw indicates that button of the microphone 60 is pressed and a voice communication activity is about to begin. When the microphone 60 is not connected to the microphone coupling 62 or a voice communication activity is not on, the microphone current 202 can be disconnected (such as by ceasing to generate this current) or set at very low level or powered in the discontinuous mode for voice activity detection in order to save power.

In an embodiment of the present invention, the detection signal generator 208 periodically asserts the microphone detection signal 212 to trigger the generation of the microphone current 202 and to periodically test whether a microphone is connected, such as one every 1 msec, 10 msec, 100 msec, 1 sec, or other time interval. The period can optionally depend on the particular application being executed by processing module 225, as indicated by a data line or data lines (not expressly shown) or other signaling generated by processing module 225 and received by detection signal generator 208. In an alternative embodiment, the detection signal generator 208 periodically asserts the microphone detection signal 212 repetitively, but not necessarily on a periodic basis, depending, for instance, on the particular application being executed by processing module 225.

In an embodiment of the present invention, the microphone detection module 204 detects when the microphone is connected to the microphone coupling by sampling the impedance of the microphone coupling or equivalently, the current draw, after waiting a settling time after the microphone detection signal 212 (or the microphone current 202) is asserted, to compensate for the time constant of the microphone, the amount of capacitive coupling and/or inductive loading. The impedance of the microphone coupling can be measured by the microphone detection module 204 by comparing the impedance, voltage or current to one or more thresholds that distinguish between states when a microphone is connected and disconnected. When the measured impedance indicates that the microphone 60 is connected to the microphone coupling 62, the microphone detection module 204 generates an interrupt signal 218 to the processing module 225. In response to this interrupt signal 218, the processing module 225 can execute operational instructions stored in memory that cause the processing module to execute a test routine, such as test routine 232, to confirm that the microphone is connected to the microphone. coupling. In particular, the processing module 225 can operate its own test to analyze audio data 214 to confirm if the microphone 60 is connected or the button is pressed. If so, the processing module 225 can execute operational instructions that cause the processing module to assert a command, such as power command 216 that caused the microphone power module 200 to continue to supply the microphone current 202. If not, an alternative power command, or absence of a power command 216 after a time-out period can cause the microphone power module 200 to shut down the microphone current 202 and to run the detection discontinuously.

In an embodiment of the present invention the microphone detection module 204 compares the microphone impedance 206 to a microphone impedance range that corresponds to the expected impedance of the microphone 60 such as is approximately 1 kΩ-2 kΩ, less than 5 kΩ, or other impedance range. The microphone detection circuit 204 sets a microphone present flag, such as interrupt signal 218 or other data signal used by processing module 225 to execute a test routine, launch an audio application or take other steps that are appropriate to the new connection of the microphone 60. In addition or in the alternative, the microphone detection module 204 can couple the microphone present signal to the microphone power module 200, detection signal generator 208 and/or audio codec 214 to take appropriate steps if a microphone is detected, such as processing audio data 220 by audio codec 214, continuing the microphone current 202 generated by microphone power module 200 and/or suspending the microphone detection signal 212 until the communication device 10 or 30, or voice data RF IC 50 or 70 is powered down.

In a further embodiment of the present invention, the microphone detection module 204 compares the microphone impedance 206 to a low impedance threshold, less than the standby impedance of the microphone 60, and sets a microphone present flag and a button depressed flag when the microphone coupling impedance compares favorably to a low impedance threshold. The button depressed flag can indicate to the processing module 225 that microphone button is depressed and the microphone 60 is generating voice signals. In addition, the microphone detection module can includes a debounce filter 210 for filtering the microphone coupling voltage. The debounce filter can include a low-pass filter, such as an audio filter for filtering audio signals from the microphone voltage to yield a more accurate measure of microphone impedance 206 when voice signals are being generated.

In a further embodiment of the present invention, after the microphone detection module 204 detects that the microphone is connected to the microphone coupling, the microphone detection module 204 compares the impedances of the microphone coupling or equivalently, the current draw, between two measurements, such as a current measurement and a prior stored measurement. The difference is compared to one or more thresholds that distinguish between states when a microphone is connected with the button depressed and when a microphone is connected with the button pressed. When the measured impedance difference indicates that the microphone 60 button is pressed, the microphone detection module 204 generates an interrupt signal 219 to the processing module 225. In response to this interrupt signal 218, the processing module 225 can execute operational instructions stored in memory that cause the processing module to execute a test routine, such as test routine 233, to confirm that the microphone is connected to the microphone coupling with the button pressed. In particular, the processing module 225 can operate its own test to analyze audio data 214 to confirm if the microphone 60 is connected and the button is pressed. If so, the processing module 225 can execute operational instructions that cause the processing module to assert a command, such as power command 216 that caused the microphone power module 200 to continue to supply the microphone current 202. If not, an alternative power command, or absence of a power command 216 after a time-out period can cause the microphone power module 200 to shut down the microphone current 202 and to run the detection discontinuously.

The various modules and circuitry of voice data RF IC 50 or 70 that are shown in conjunction with FIG. 5 can be implemented with one or more dedicated or shared field programmable gate arrays, programmable logic devices, state machines, logic circuits, analog circuits, digital circuits, and/or any devices or a other processing devices. In addition, while particular circuits and modules of voice data RF IC 50 or 70 are shown this integrated circuit includes other modules including one or more RF modules, baseband modules, drivers and interface modules as described in conjunction with FIGS. 3 and 4 or otherwise required by communication devices 10 and 30 to perform the various functions and features associated with the broad spectrum of applications performed thereby.

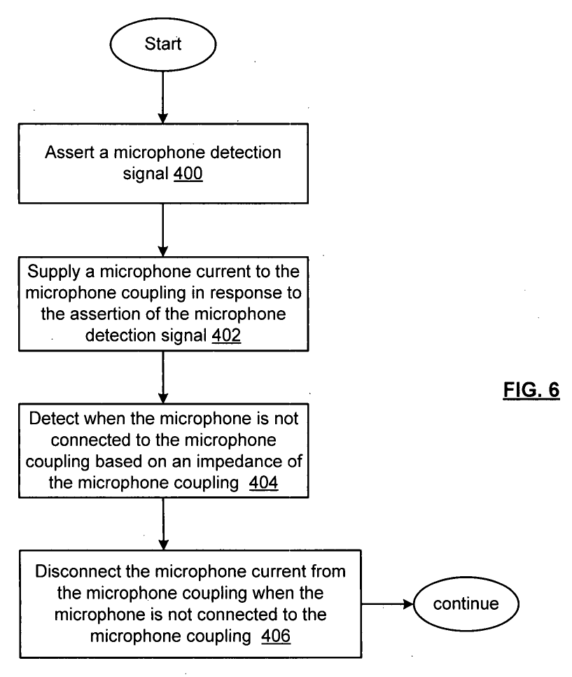

FIG. 6 is a flow chart of an embodiment of a method in accordance with the present invention. In particular, a method is presented for use in conjunction with one or more of the functions and features described in conjunction with FIGS. 1-5. In step 400, a microphone detection signal is asserted. In step 402, a microphone current is supplied to the microphone coupling in response to the assertion of the microphone detection signal. In step 404, the method detects when the microphone is not connected to the microphone coupling based on an impedance of the microphone coupling. In step 406, the method disconnects the microphone current from the microphone coupling when the microphone is not connected to the microphone coupling.

In an embodiment of the present invention, step 400 is performed periodically. Further step 404 can include sampling the impedance of the microphone coupling after a microphone settling time, comparing the microphone impedance to a microphone impedance range, comparing the microphone impedance to a low impedance threshold, and/or low-pass filtering the microphone coupling voltage.

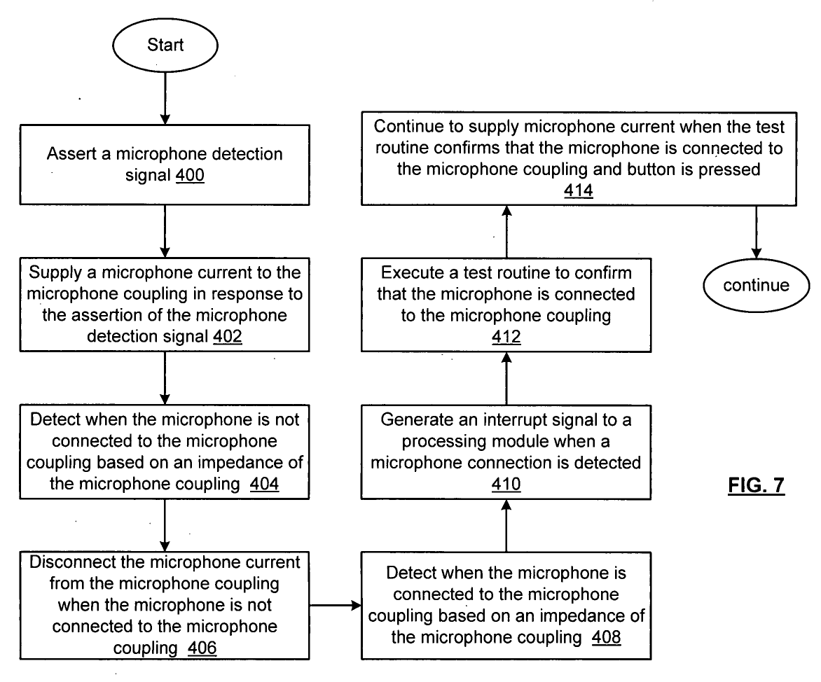

FIG. 7 is a flow chart of an embodiment of a method in accordance with the present invention. In particular, a method is presented that includes many of the steps of FIG. 6 that are referred to by common reference numerals. In addition, the method includes step 408 of detecting when the microphone is connected to the microphone coupling based on an impedance of the microphone coupling, and step 410 of generating an interrupt signal to a processing module when the microphone is coupled to the microphone coupling. In step 412, a test routine is executed to confirm that the microphone is connected to the microphone coupling. In step 414, the microphone current is continued to be supplied when the test routine confirms that the microphone is connected to the microphone coupling.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A circuit for detecting when a microphone is connected to a microphone coupling, the circuit comprising:
a detection signal generator that asserts a microphone detection signal;
a microphone power module, coupled to the detection signal generator, that supplies a microphone current to the microphone coupling in response to the assertion of the microphone detection signal; and
a microphone detection module, coupled to the detection signal generator and the microphone power module, that detects when the microphone is not connected to the microphone coupling based on an impedance of the microphone coupling;
wherein the microphone power module disconnects the microphone current from the microphone coupling when the microphone is not connected to the microphone coupling.

2. The circuit of claim 1 wherein the detection signal generator periodically asserts the microphone detection signal.

3. The circuit of claim 1 wherein the microphone detection module is implemented as part of a voice, data and radio frequency integrated circuit that includes a processing module and a memory module.

4. The circuit of claim 3 wherein the microphone detection module detects when the microphone is connected to the microphone coupling based on an impedance of the microphone coupling, and generates an interrupt signal to the processing module when the microphone is coupled to the microphone coupling.

5. The circuit of claim 4 wherein the memory module stores operational instructions that cause the processing module, in response to the interrupt signal, to execute a test routine to confirm that the microphone is connected to the microphone coupling.

6. The circuit of claim 4 wherein the memory module stores operational instructions that cause the processing module, in response to the interrupt signal, to execute a test routine to determine if a microphone button is pressed.

7. The circuit of claim 5 wherein the processor module is coupled to the microphone power module, wherein the memory module stores operational instructions that cause the processing module to command the microphone power module to continue to supply the microphone current when the test routine confirms that the microphone is connected to the microphone coupling.

8. The circuit of claim 1 wherein the microphone detection module samples the impedance of the microphone coupling after a microphone settling time.

9. The circuit of claim 1 wherein the microphone detection module:
compares the impedance to a impedance range; and
sets a microphone present flag when the impedance compares favorably to the impedance range.

10. The circuit of claim 1 wherein the microphone detection module:
compares the impedance to a low impedance threshold; and
sets a microphone present flag and a button depressed flag when the impedance compares favorably to the low impedance threshold.

11. The circuit of claim 1 wherein the microphone detection module includes a debounce filter for filtering a microphone coupling voltage, the debounce filter including a low-pass filter.

12. The circuit of claim 1 wherein the microphone detection module:
compares the impedance to a stored impedance; and
sets a microphone present flag when the impedance compares favorably to the stored impedance.

13. A method for detecting when a microphone is connected to a microphone coupling, the method comprising:
asserting a microphone detection signal;
supplying a microphone current to the microphone coupling in response to the assertion of the microphone detection signal;
detecting when the microphone is not connected to the microphone coupling based on an impedance of the microphone coupling; and
disconnecting the microphone current from the microphone coupling when the microphone is not connected to the microphone coupling.

14. The method of claim 13 wherein the step of asserting the microphone detection signal is performed periodically.

15. The method of claim 14 further comprising:
detecting when the microphone is connected to the microphone coupling based on an impedance of the microphone coupling; and
generating an interrupt signal to a processing module when the microphone is coupled to the microphone coupling.

16. The method of claim 15 further comprising:
executing a test routine to confirm that the microphone is connected to the microphone coupling.

17. The method of claim 15 further comprising:
executing a test routine to determine if a microphone button is pressed.

18. The method of claim 16 further comprising:
continuing to supply the microphone current when the test routine confirms that the microphone is connected to the microphone coupling.

19. The method of claim 13 wherein the step of detecting when the microphone is not connected includes sampling the impedance of the microphone coupling after a microphone settling time.

20. The method of claim 13 wherein the step of detecting when the microphone is not connected includes comparing the impedance to a impedance range.

21. The method of claim 13 wherein the step of detecting when the microphone is not connected includes comparing the impedance to a low impedance threshold.

22. The method of claim 13 wherein the step of detecting when the microphone is not connected includes low-pass filtering a microphone coupling voltage.

23. The method of claim 13 further comprising:
comparing the impedance to a stored impedance; and
setting a microphone present flag when the impedance compares favorably to the stored impedance.

24. A voice, data and radio frequency integrated circuit comprising:
a detection signal generator that asserts a microphone detection signal;
a microphone power module, coupled to the detection signal generator, that supplies a microphone current to the microphone coupling in response to the assertion of the microphone detection signal;
a microphone detection module, coupled to the detection signal generator and the microphone power module, that detects when the microphone is not connected to the microphone coupling and that detects when the microphone is connected to the microphone coupling, based on an impedance of the microphone coupling;
a memory module that stores a plurality of operational instructions;
a processing module that executes the plurality of operational instructions to perform a voice application when the microphone is connected;
wherein the microphone power module disconnects the microphone current from the microphone coupling when the microphone is not connected to the microphone coupling.

25. The voice, data and radio frequency integrated circuit of claim 24 wherein the detection signal generator periodically asserts the microphone detection signal.

26. The voice, data and radio frequency integrated circuit of claim 24 wherein the microphone detection module detects when the microphone is connected to the microphone coupling based on an impedance of the microphone coupling, and generates an interrupt signal to the processing module when the microphone is coupled to the microphone coupling.

27. The voice, data and radio frequency integrated circuit of claim 26 wherein the memory module stores operational instructions that cause the processing module, in response to the interrupt signal, to execute a test routine to confirm that the microphone is connected to the microphone coupling.

28. The voice, data and radio frequency integrated circuit of claim 26 wherein the memory module stores operational instructions that cause the processing module, in response to the interrupt signal, to execute a test routine to determine if a microphone button is pressed.

29. The voice, data and radio frequency integrated circuit of claim 27 wherein the processor module is coupled to the microphone power module, wherein the memory module stores operational instructions that cause the processing module to command the microphone power module to continue to supply the microphone current when the test routine confirms that the microphone is connected to the microphone coupling.

30. The voice, data and radio frequency integrated circuit of claim 24 wherein the microphone detection module samples the impedance of the microphone coupling after a microphone settling time.

31. The voice, data and radio frequency integrated circuit of claim 24 wherein the microphone detection module:
compares the impedance to a impedance range; and
sets a microphone present flag when the impedance compares favorably to the impedance range.

32. The voice, data and radio frequency integrated circuit of claim 24 wherein the microphone detection module:
compares the impedance to a low impedance threshold; and
sets a microphone present flag and a button depressed flag when the impedance compares favorably to the low impedance threshold.

33. The voice, data and radio frequency integrated circuit of claim 24 wherein the microphone detection module includes a debounce filter for filtering a microphone coupling voltage, the debounce filter including a low-pass filter.

34. The voice, data and radio frequency integrated circuit of claim 24 wherein the microphone detection module:
compares the impedance to a stored impedance; and
sets a microphone present flag when the impedance compares favorably to the stored impedance.
